(19) United States
(12) Patent Application Publication
(10) Pub. No.: US 2025/0309293 A1
(43) Pub. Date: Oct. 2, 2025

(54) ENERGY GENERATION SYSTEM

(71) Applicants: Hyundai Motor Company, Seoul (KR); Kia Corporation, Seoul (KR)

(72) Inventors: Ju Ho Han, Hwaseong-si (KR); Seung Yun Kwak, Hwaseong-si (KR); Sang Hyuk Ha, Hwaseong-si (KR)

(21) Appl. No.: 19/080,385

(22) Filed: Mar. 14, 2025

(30) Foreign Application Priority Data
Apr. 1, 2024 (KR) 10-2024-0044344

(51) Int. Cl. H01M 8/04119; H01M 8/0432; H01M 8/0438; H01M 8/04492; H01M 8/04746; H01M 8/04858

(52) U.S. Cl. CPC H01M 8/04149; H01M 8/04171; H01M 8/0432; H01M 8/0438; H01M 8/04492; H01M 8/04776; H01M 8/0494

(57) ABSTRACT

An embodiment of the present disclosure relates to an energy generation system including a first energy generation part configured to generate electrical energy on the basis of an electrochemical reaction of a target fluid, and a second energy generation part configured to operate by receiving water discharged from the first energy generation part and generate electrical energy on the basis of a potential difference made by a movement and evaporation of the water, thereby obtaining an advantageous effect of improving energy generation efficiency.

### CROSS-REFERENCE TO RELATED APPLICATIONS

This application claims priority to and the benefit of Korean Patent Application No. 10-2024-0044344 filed in the Korean Intellectual Property Office on Apr. 1, 2024, the entire contents of which are incorporated herein by reference.

### TECHNICAL FIELD

The present disclosure relates to an energy generation system, and more particularly, to an energy generation system capable of improving energy generation efficiency, stability, and reliability.

### BACKGROUND

With the growth of population and the development of industry, the demand for fossil fuel is increasing, and the increase in demand for fossil fuel causes the problem of depletion of resources and the problem of increasing international prices of fossil fuel.

In addition, there is a growing movement to reduce the use of fossil fuel as it is recognized that fossil fuel causes global warming. Therefore, research is being conducted on renewable energy that utilizes solar energy, water, geothermal energy, and rain to generate energy.

Among other things, recently, the development has been conducted on fuel cell systems that produce electrical energy from an electrochemical reaction of fuel.

In general, the fuel cell system may include a fuel cell stack configured to generate electricity by means of a redox reaction between fuel (e.g., hydrogen) and oxidant (e.g., air), a fuel supply device configured to supply fuel (hydrogen) to the fuel cell stack, an air supply device configured to supply the fuel cell stack with air which is an oxidant required for an electrochemical reaction, and a thermal management system (TMS) configured to discharge reaction heat, which is generated from the fuel cell stack, to the outside of the system and control temperatures of the fuel cell stack.

Meanwhile, recently, various studies have been conducted to improve energy generation efficiency while minimizing a load of the fuel cell stack, but the study results are still insufficient. Accordingly, there is a need to develop a technology to improve energy generation efficiency while minimizing a load of the fuel cell stack.

### SUMMARY

The present disclosure has been made in an effort to provide an energy generation system capable of improving energy generation efficiency.

The present disclosure has also been made in an effort to produce electrical energy on the basis of a potential difference made by a movement and evaporation of water while producing electrical energy on the basis of an electrochemical reaction of fuel.

The present disclosure has also been made in an effort to operate a second energy generation part (produce electrical energy) by using water that is a by-product from a first energy generation part.

The present disclosure has also been made in an effort to minimize a load of a fuel cell stack and improve performance and operational efficiency.

The present disclosure has also been made in an effort to simplify a structure and improve spatial utilization and a degree of design freedom.

The present disclosure has also been made in an effort to efficiently operate a second energy generation part without additionally providing additional devices for operating the second energy generation part (a water supply means for supplying water and an air supply device for supplying high-temperature air).

The present disclosure has also been made in an effort to stably maintain an arrangement state of an energy generation membrane for producing electrical energy and stably maintain an environment for effectively ensuring a movement (movement by capillarity) and evaporation of water supplied to the energy generation membrane.

The goals to be achieved by the embodiments are not limited to the above-mentioned goals, but also include goals or effects that may be understood from the solutions or embodiments described below.

In order to achieve the above-mentioned goals, an exemplary embodiment of the present disclosure provides an energy generation system including: a first energy generation part configured to generate electrical energy on the basis of an electrochemical reaction of a target fluid; and a second energy generation part configured to operate by receiving water discharged from the first energy generation part and generate electrical energy on the basis of a potential difference made by a movement and evaporation of the water.

This is to improve energy generation efficiency, stability, and reliability.

That is, when various electronic devices (e.g., electrical components in vehicles) applied to mobility vehicles and the like need to rapidly operate, it is difficult to efficiently operate various types of electronic devices only by using electrical energy generated by the fuel cell stack, and a load of the fuel cell stack increases.

In contrast, in the embodiment of the present disclosure, it is possible to produce electrical energy on the basis of a potential difference made by the movement and evaporation of the water while producing electrical energy on the basis of the electrochemical reaction of fuel. Therefore, it is possible to obtain an advantageous effect of further improving the energy generation efficiency, minimizing a load of the first energy generation part (fuel cell stack), and improving the performance and operational efficiency.

In particular, in the embodiment of the present disclosure, the water, which is a by-product from the first energy generation part, is supplied to the second energy generation part without additionally providing a separate water supply means for supplying water to the second energy generation part. Therefore, it is possible to obtain an advantageous effect of simplifying the structure and improving the spatial utilization and the degree of design freedom.

The first energy generation part may have various structures capable of generating electrical energy on the basis of the electrochemical reaction of the target fluid.

According to the exemplary embodiment of the present disclosure, the first energy generation part may include: a fuel cell stack; an air compressor provided in an air supply line through which air is supplied to the fuel cell stack, the air compressor being configured to compress the air to be supplied to the fuel cell stack; and a humidifier provided in the air supply line and configured to humidify the air to be supplied to the fuel cell stack by using the water discharged from the fuel cell stack.

The water discharged from the fuel cell stack may be supplied to the second energy generation part in various ways in accordance with required conditions and design specifications.

According to the exemplary embodiment of the present disclosure, the energy generation system may include: a first connection line configured to connect the humidifier and the second energy generation part, in which the water discharged from the fuel cell stack passes through the humidifier and then is supplied to the second energy generation part along the first connection line.

The second energy generation part may have various structures capable of generating electrical energy on the basis of a potential difference made by the movement and evaporation of the water while operating by receiving the water discharged from the first energy generation part (e.g., the fuel cell stack).

According to the exemplary embodiment of the present disclosure, the second energy generation part may include: a casing part having a casing penetration portion; an energy generation membrane supported in the casing part so as to be exposed to the outside of the casing part through the casing penetration portion and configured to generate electrical energy on the basis of a potential difference between two opposite ends thereof made by the movement and evaporation of the water; an absorptive member provided to penetrate the casing part while being in contact with the energy generation membrane and configured to supply the water to the energy generation membrane; and a housing member provided to surround an entire periphery of the casing part.

As described above, in the embodiment of the present disclosure, the energy generation membrane is supported by using the casing part, and the water is supplied to the energy generation membrane by means of the absorptive member. Therefore, it is possible to obtain an advantageous effect of stably maintaining the arrangement state of the energy generation membrane configured to generate electrical energy and stably maintaining the environment for effectively ensuring the movement (movement by capillarity) and evaporation of the water supplied to the energy generation membrane.

In particular, in the embodiment of the present disclosure, the casing part may maintain the posture and environment in which the energy generation membrane may generate electrical energy, such that the water may be continuously supplied to the energy generation membrane, and the movement and evaporation of the water supplied to the energy generation membrane may be continuously performed. Therefore, it is possible to continuously implement the generation of electrical energy by the energy generation membrane.

Furthermore, in the embodiment of the present disclosure, an appropriate amount of water, which is required for the energy generation membrane to generate electrical energy, may be stably supplied to the energy generation membrane by supplying the water slowly to the energy generation membrane by means of the absorptive member without supplying the water directly to the energy generation membrane. Therefore, it is possible to obtain an advantageous effect of improving the electrical energy generation efficiency and stability.

The air introduced into the second energy generation part may be heated in various ways in accordance with required conditions and design specifications.

According to the exemplary embodiment of the present disclosure, the energy generation system may include: a second connection line having one end disposed between the air compressor and the humidifier and connected to the air supply line, and the other end connected to the second energy generation part, in which a part of the air having passed through the air compressor is supplied to the second energy generation part along the second connection line.

As described above, in the embodiment of the present disclosure, the high-temperature air having passed through the air compressor may be supplied to the second energy generation part without additionally providing an air supply device for supplying high-temperature air to the second energy generation part. Therefore, it is possible to obtain an advantageous effect of improving the energy efficiency, simplifying the structure, and improving the spatial utilization and the degree of design freedom.

According to the exemplary embodiment of the present disclosure, the energy generation system may include: a temperature sensor provided in the second energy generation part and configured to sense an internal temperature of the second energy generation part; and a humidity sensor provided in the second energy generation part and configured to sense an internal humidity of the second energy generation part, in which the valve selectively opens or closes the second connection line in response to signals detected by the temperature sensor and the humidity sensor.

As described above, in the embodiment of the present disclosure, the second connection line is selectively opened or closed on the basis of the internal temperature and the internal humidity of the housing member. Therefore, it is possible to obtain an advantageous effect of optimizing the electrical energy generation condition by the energy generation membrane and improving the electrical energy generation efficiency by the energy generation membrane.

According to the exemplary embodiment of the present disclosure, the energy generation system may include: an air flow rate sensor provided in the second connection line and configured to sense a flow rate of air moving along the second connection line; and a controller configured to control an opening ratio of the valve in response to a signal detected by the air flow rate sensor.

As described above, in the embodiment of the present disclosure, the opening ratio of the valve is adjusted on the basis of the flow rate of the air moving along the second connection line. Therefore, it is possible to obtain an advantageous effect of further optimizing the electrical energy generation condition of the energy generation membrane and further improving the electrical energy generation efficiency by the energy generation membrane.

The energy generation membrane may have various structures capable of generating electrical energy on the basis of a potential difference between the two opposite ends (two opposite ends of the energy generation membrane) made when the water supplied to one end of the energy generation membrane evaporates while being moved to the other end of the energy generation membrane (moved by capillarity).

According to the exemplary embodiment of the present disclosure, the energy generation membrane may include: a hydrophilic fiber membrane; and a conductive polymer layer applied onto a surface of the hydrophilic fiber membrane.

According to the exemplary embodiment of the present disclosure, the casing part may include only a single casing member or be provided by assembling or connecting a plurality of casing members.

According to the exemplary embodiment of the present disclosure, the casing part may include: a first casing member configured to support the energy generation membrane; and a second casing member configured to support the energy generation membrane independently of the first casing member, and the absorptive member may be provided to continuously penetrate the first casing member and the second casing member.

According to the exemplary embodiment of the present disclosure, the second casing member may be connected in series to an end of the first casing member in a longitudinal direction of the absorptive member.

According to the exemplary embodiment of the present disclosure, the energy generation system may include: a guide protrusion provided at one end of the second casing member corresponding to one end of the first casing member; and a guide groove provided at one end of the first casing member and configured to accommodate the guide protrusion.

As described above, in the embodiment of the present disclosure, the guide protrusion provided at one end of the second casing member is accommodated in the guide groove provided at one end of the first casing member. Therefore, it is possible to obtain an advantageous effect of suppressing the withdrawal of the second casing from the first casing and more stably maintaining the arrangement state.

The first casing member and the second casing member may have various structures capable of independently supporting the energy generation membrane.

According to the exemplary embodiment of the present disclosure, the first casing member and the second casing member may have the same structure.

Because the first casing member and the second casing member have the same structure as described above, the first casing member and the second casing member may be manufactured by using a single manufacturing device in common. Therefore, it is possible to obtain an advantageous effect of simplifying the manufacturing process and reducing the manufacturing costs.

According to the exemplary embodiment of the present disclosure, the energy generation system may include: a partition member configured to divide an internal space of the casing part into a first space and a second space, in which the energy generation membrane includes: a first energy generation membrane accommodated in the first space; and a second energy generation membrane accommodated in the second space.

The partition member may have various structures capable of dividing the internal space of the casing part into the first space and the second space.

According to the exemplary embodiment of the present disclosure, the partition member may include: a partition body provided in the casing part and spaced apart from an inner surface of the casing part; a first support protrusion provided on one surface of the partition body and supported on the inner surface of the casing part; and a second support protrusion provided on the other surface of the partition body and supported on the inner surface of the casing part.

According to the exemplary embodiment of the present disclosure, an inner surface of the first energy generation membrane and an inner surface of the second energy generation membrane may be tightly attached to the partition member, and an outer surface of the first energy generation membrane and an outer surface of the second energy generation membrane may be tightly attached to an inner surface of the casing part.

According to the exemplary embodiment of the present disclosure, the absorptive member may include: a first absorptive member provided to penetrate the casing part while being in contact with the first energy generation membrane and configured to supply the water to the first energy generation membrane; and a second absorptive member provided to penetrate the casing part while being in contact with the second energy generation membrane and configured to supply the water to the second energy generation membrane.

According to the exemplary embodiment of the present disclosure, the energy generation system may include: a first electrode port part provided in the casing part so that one end of the energy generation membrane is exposed; and a second electrode port part provided in the casing part so that the other end of the energy generation membrane is exposed.

According to the embodiment of the present disclosure described above, it is possible to obtain an advantageous effect of improving the energy generation efficiency.

In particular, according to the embodiment of the present disclosure, it is possible to produce electrical energy on the basis of a potential difference made by the movement and evaporation of the water while producing electrical energy on the basis of the electrochemical reaction of fuel. Therefore, it is possible to obtain an advantageous effect of further improving the energy generation efficiency.

Among other things, according to the embodiment of the present disclosure, it is possible to operate the second energy generation part (produce electrical energy) by using the water that is a by-product from the first energy generation part.

In addition, according to the embodiment of the present disclosure, it is possible to obtain an advantageous effect of minimizing a load of the fuel cell stack and improving the performance and operational efficiency.

In addition, according to the embodiment of the present disclosure, it is possible to obtain an advantageous effect of simplifying the structure and improving the spatial utilization and the degree of design freedom.

In particular, according to the embodiment of the present disclosure, it is possible to efficiently operate the second energy generation part without additionally providing additional devices for operating the second energy generation part (a water supply means for supplying water and an air supply device for supplying high-temperature air).

In addition, according to the embodiment of the present disclosure, it is possible to obtain an advantageous effect of stably maintaining the arrangement state of the energy generation membrane configured to generate electrical energy and stably maintaining the environment for effectively ensuring the movement (movement by capillarity) and evaporation of the water supplied to the energy generation membrane.

### BRIEF DESCRIPTION OF THE DRAWINGS

FIG. 1 is a block diagram of an energy generation system according to an embodiment of the present disclosure.

FIGS. 2 and 3 are views of a second energy generation part of the energy generation system according to the embodiment of the present disclosure.

FIGS. 4 and 5 are views of a casing part of the energy generation system according to the embodiment of the present disclosure.

FIG. 6 is a view of a guide protrusion and a guide groove of the energy generation system according to the embodiment of the present disclosure.

FIG. 7 is a view of a movement route for water in the energy generation system according to the embodiment of the present disclosure.

FIG. 8 is a table representing a condition in which a valve is opened or closed depending on a temperature and a humidity in the energy generation system according to the embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings.

However, the technical spirit of the present disclosure is not limited to the embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element. The nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

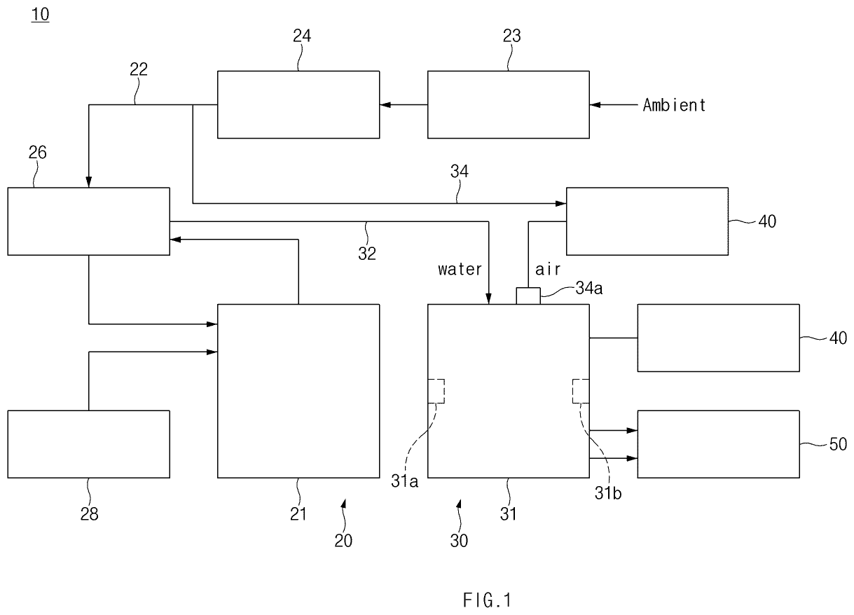

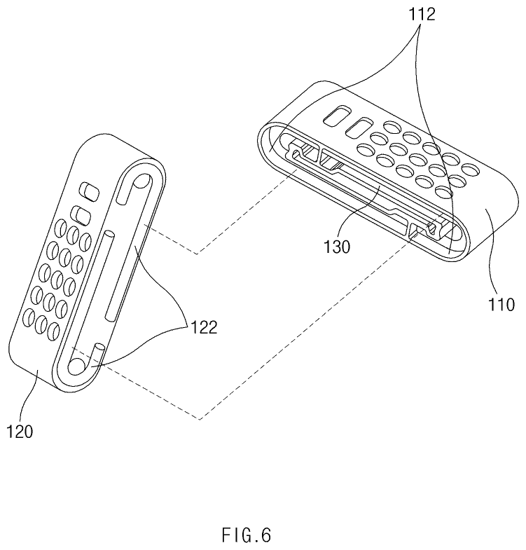

With reference to FIGS. 1 to 8, an energy generation system 10 according to an embodiment of the present disclosure includes a first energy generation part 20 configured to generate electrical energy on the basis of an electrochemical reaction of a target fluid, and a second energy generation part 30 configured to operate by receiving water discharged from the first energy generation part 20 and generate electrical energy on the basis of a potential difference made by a movement and evaporation of the water.

For reference, the energy generation system 10 according to the embodiment of the present disclosure may be applied to various objects in accordance with required conditions and design specifications. The present disclosure is not restricted or limited by the type of object to which the energy generation system 10 is applied.

For example, according to the embodiment of the present disclosure, the energy generation system 10 may be applied to various mobility vehicles such as automobiles, ships, and airplanes.

With reference to FIG. 1, the first energy generation part 20 is configured to generate electrical energy on the basis of an electrochemical reaction of the target fluid.

The first energy generation part 20 may have various structures capable of generating electrical energy on the basis of the electrochemical reaction of the target fluid. The present disclosure is not restricted or limited by the structure of the first energy generation part 20.

According to the exemplary embodiment of the present disclosure, the first energy generation part 20 may include a fuel cell stack 21, an air compressor 24 provided in an air supply line 22 through which air is supplied to the fuel cell stack 21, the air compressor 24 being configured to compress the air to be supplied to the fuel cell stack 21, and a humidifier 26 provided in the air supply line 22 and configured to humidify the air to be supplied to the fuel cell stack 21 by using water discharged from the fuel cell stack 21.

The fuel cell stack 21 refers to a kind of power generation device that generates electrical energy by means of an electrochemical reaction (redox reaction) between fuel (e.g., hydrogen) and oxidant (e.g., air), and the fuel cell stack may be configured by stacking several tens or hundreds of fuel cells (unit cells) in series.

The fuel cell may have various structures capable of producing electricity by means of a redox reaction between fuel (e.g., hydrogen) and oxidant (e.g., air).

For example, the fuel cell may include: a membrane electrode assembly (MEA) (not illustrated) having catalyst electrode layers in which electrochemical reactions occur and which are attached to two opposite sides of an electrolyte membrane through which hydrogen ions move; a gas diffusion layer (GDL) (not illustrated) configured to uniformly distribute reactant gases and transfer generated electrical energy; a gasket (not illustrated) and a fastener (not illustrated) configured to maintain leakproof sealability for the reactant gases and a coolant and maintain an appropriate fastening pressure; and a separator (bipolar plate) (not illustrated) configured to move the reactant gases and the coolant.

More specifically, in the fuel cell, hydrogen, which is fuel, and air (oxygen), which is an oxidant, are supplied to an anode and a cathode of the membrane electrode assembly, respectively, through flow paths in the separator, such that the hydrogen is supplied to the anode, and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires, and the electric current is generated as a result of the flow of the electrons.

The air supply line 22 may be connected to the fuel cell stack 21, and outside air may be supplied to the fuel cell stack 21 along the air supply line 22.

The air supply line 22 may have various structures in accordance with required conditions and design specifications. The present disclosure is not restricted or limited by the structure and shape of the air supply line 22.

A hydrogen supply line may be connected to the fuel cell stack 21, and hydrogen stored in a hydrogen storage part 28 may be supplied to the fuel cell stack 21 through the hydrogen supply line (not illustrated).

The hydrogen supply line may have various structures in accordance with required conditions and design specifications. The present disclosure is not restricted or limited by the structure and shape of the hydrogen supply line.

The air compressor 24 is provided in the air supply line 22. The air compressor 24 compresses the air supplied along the air supply line 22 and supplies the compressed air to the fuel cell stack 21.

More specifically, the air compressor 24 may compress the air so that the air to be supplied to the fuel cell stack 21 may have a sufficient pressure that enables the air to pass through a flow path in the fuel cell stack 21.

Various air compressors 24 capable of compressing air may be used as the air compressor 24. The present disclosure is not restricted or limited by the type and structure of the air compressor 24. For example, the air compressor 24 may be configured to compress and supply the air by using a centrifugal force generated by a rotation of a rotor (not illustrated).

In addition, an air filter 23 may be provided in the air supply line 22, positioned at an upstream side of the air compressor 24, and configured to filter the air introduced into the air supply line 22.

Meanwhile, the electrolyte membrane of the membrane electrode assembly needs to be maintained at a predetermined humidity or higher so that the fuel cell stack 21 normally operates.

To this end, the air supplied along the air supply line 22 may pass through the humidifier 26, and the air to be supplied to the fuel cell stack 21 along the air supply line 22 may be humidified while passing through the humidifier 26. In this case, the humidification of air is defined as a process of increasing the humidity of the air.

The humidifier 26 is provided in the air supply line 22, positioned between the fuel cell stack 21 and the air compressor 24, and configured to humidify air (dry air) to be supplied to the fuel cell stack 21 by using water (moist air) discharged from the fuel cell stack 21.

The humidifier 26 may have various structures capable of humidifying the dry air by using the water (moist air) discharged from the fuel cell stack 21. The present disclosure is not restricted or limited by the structure of the humidifier 26.

According to the exemplary embodiment of the present disclosure, the humidifier 26 may include an inflow gas supply port (not illustrated) through which inflow gas (dry air) is introduced (supplied), an inflow gas discharge port (not illustrated) through which the (humidified) inflow gas having passed through the interior of the humidifier 26 is discharged, a moist air supply port (not illustrated) through which moist air (water) discharged from the fuel cell stack 21 is supplied, and a moist air discharge port (not illustrated) through which the moist air, which has humidified the inflow gas, is discharged to the outside.

The inflow gas supplied through the inflow gas supply port may be humidified by the moist air while passing through a humidification membrane (e.g., a hollow fiber membrane) (not illustrated) disposed in the humidifier 26. Then, the humidified inflow gas may be supplied to the fuel cell stack 21 through the inflow gas discharge port.

Further, the moist air (water) discharged from the fuel cell stack 21 may be supplied to the moist air supply port and humidify the inflow gas in the humidifier 26. Then, a part of the moist gas may be discharged to the outside through the moist air discharge port, and the remaining part of the moist gas may be supplied to the second energy generation part 30.

The water discharged from the fuel cell stack 21 may be supplied to the second energy generation part 30 in various ways in accordance with required conditions and design specifications.

According to the exemplary embodiment of the present disclosure, the energy generation system 10 may include a first connection line 32 configured to connect the humidifier 26 and the second energy generation part 30 (e.g., a housing member). The water discharged from the fuel cell stack 21 may pass through the humidifier 26 and then be supplied to the second energy generation part 30 along the first connection line 32.

As described above, in the embodiment of the present disclosure, the water, which is a by-product from the fuel cell stack 21, is supplied to the second energy generation part 30 without additionally providing a separate water supply means for supplying water to the second energy generation part 30. Therefore, it is possible to obtain an advantageous effect of simplifying the structure and improving the spatial utilization and the degree of design freedom.

With reference to FIGS. 1 to 7, the second energy generation part 30 may have various structures capable of generating electrical energy on the basis of a potential difference made by the movement and evaporation of the water while operating by receiving the water discharged from the first energy generation part 20 (e.g., the fuel cell stack). The present disclosure is not restricted or limited by the structure of the second energy generation part 30.

According to the exemplary embodiment of the present disclosure, the second energy generation part 30 may include a casing part 100 having casing penetration portions 102, energy generation membranes 200 supported in the casing part 100 so as to be exposed to the outside of the casing part 100 through the casing penetration portions 102, the energy generation membranes 200 being configured to generate electrical energy on the basis of a potential difference between two opposite ends made by the movement and evaporation of the water, absorptive members 300 provided to penetrate the casing part 100 while being in contact with the energy generation membrane 200 and configured to supply the water to the energy generation membrane 200, and a housing member 31 provided to surround an entire periphery of the casing part.

The casing part 100 is configured to support the energy generation membrane 200 configured to generate electrical energy. The casing penetration portions 102 are provided in the casing part 100 so that the water moving along the energy generation membrane 200 evaporates to the outside of the casing part 100.

The casing part 100 may have various structures capable of having the casing penetration portions 102 and supporting the energy generation membrane 200. The present disclosure is not restricted or limited by the structure and shape of the casing part 100.

For example, the casing part 100 may have a flat tubular shape having an approximately elliptical cross-sectional shape. According to another embodiment of the present disclosure, the casing part may be configured to have a quadrangular cross-sectional shape or other cross-sectional shapes.

The casing part 100 may be configured by a single casing member or configured by assembling or connecting a plurality of casing members.

Hereinafter, an example will be described in which the casing part 100 includes the plurality of casing members 110 and 120. For reference, the number of casing members constituting the casing part 100 may be variously changed in accordance with required conditions and design specifications. The present disclosure is not restricted or limited by the number of casing members.

According to the exemplary embodiment of the present disclosure, the casing part 100 may include a first casing member 110 configured to support the energy generation membrane 200, and a second casing member 120 configured to support the energy generation membrane 200 independently of the first casing member 110. The absorptive members 300 may be provided to continuously penetrate the first casing member 110 and the second casing member 120.

According to the exemplary embodiment of the present disclosure, the second casing member 120 may be connected in series to an end of the first casing member 110 in a longitudinal direction of the absorptive member 300.

According to the exemplary embodiment of the present disclosure, the energy generation system 10 may include guide protrusions 122 provided at one end of the second casing member 120 corresponding to one end of the first casing member 110, and guide grooves 112 provided at one end of the first casing member 110 so that the guide protrusions 122 may be accommodated in the guide grooves 112.

The guide protrusion 122 may have various structures capable of being accommodated in the guide groove 112. The present disclosure is not restricted or limited by the structure and shape of the guide protrusion 122. For example, the guide protrusion 122 may have an approximately “J” shape, and the guide groove 112 may have an approximately “J” shape corresponding to the guide protrusion 122.

As described above, in the embodiment of the present disclosure, the guide protrusion 122 provided at one end of the second casing member 120 is accommodated in the guide groove 112 provided at one end of the first casing member 110. Therefore, it is possible to obtain an advantageous effect of suppressing the withdrawal of the second casing from the first casing and more stably maintaining the arrangement state.

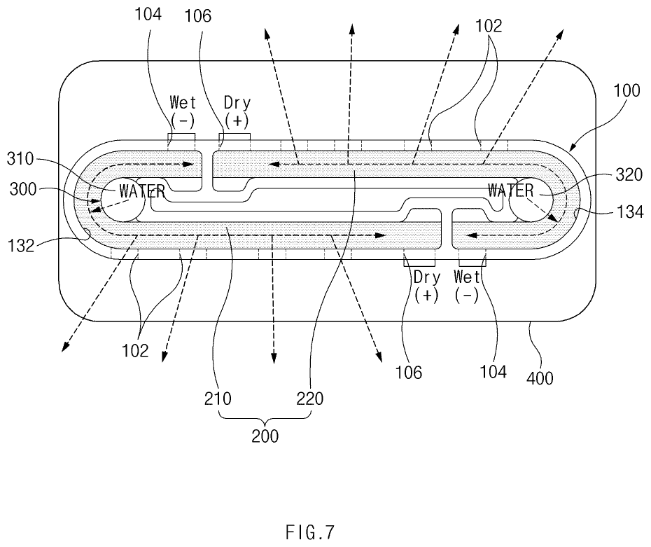

In the embodiment of the present disclosure illustrated and described above, the example has been described in which the first casing member 110 and the second casing member 120 are connected in series. However, according to another embodiment of the present disclosure, the second casing member may be stacked on an upper portion (or a lower portion) of the first casing member (the first casing member and the second casing member are connected in parallel) in a thickness direction of the first casing member (an upward/downward direction based on FIG. 7). Alternatively, the first casing member and the second casing member may be disposed to be spaced apart from each other at a predetermined interval.

The first casing member 110 and the second casing member 120 may have various structures capable of independently supporting the energy generation membrane 200. The present disclosure is not restricted or limited by the structures of the first casing member 110 and the second casing member 120.

According to the exemplary embodiment of the present disclosure, the first casing member 110 and the second casing member 120 may have the same structure.

In this case, the configuration in which the first casing member 110 and the second casing member 120 have the same structure may be understood as a configuration in which the first casing member 110 and the second casing member 120 have the same shape and size.

For example, the first casing member 110 and the second casing member 120 may each have a flat tubular shape having an approximately elliptical cross-sectional shape.

Because the first casing member 110 and the second casing member 120 have the same structure as described above, the first casing member 110 and the second casing member 120 may be manufactured by using a single manufacturing device in common. Therefore, it is possible to obtain an advantageous effect of simplifying the manufacturing process and reducing the manufacturing costs.

According to another embodiment of the present disclosure, the first casing member and the second casing member may be configured to have different shapes and sizes.

The casing penetration portions 102 are provided to evaporate the water, which moves along the energy generation membrane 200, to the outside of the casing part 100 (e.g., the first casing member and the second casing member).

The casing penetration portion 102 may be provided in the form of a hole formed through a wall surface of the casing part 100.

The casing penetration portion 102 may be variously changed in structure and number in accordance with required conditions and design specifications. The present disclosure is not restricted or limited by the structure of the casing penetration portion 102 and the number of casing penetration portions 102.

For example, the casing penetration portion 102 may have an approximately circular hole shape. The casing penetration portions 102 may be provided as a plurality of casing penetration portions 102 spaced apart from one another at a predetermined interval. Hereinafter, an example will be described in which the plurality of casing penetration portions 102 are formed in one surface (a top surface based on FIG. 7) and the other surface (a bottom surface based on FIG. 7) of the casing part 100 and spaced apart from one another in a longitudinal direction (first direction) and a width direction (second direction) of the casing part 100.

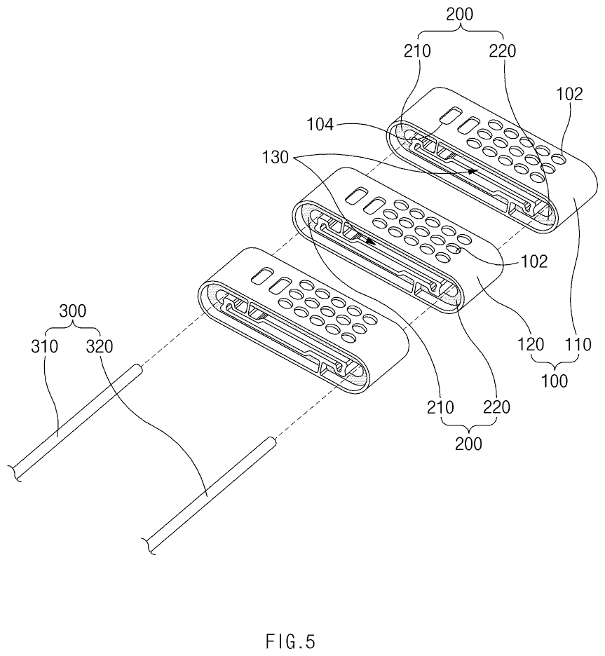

For reference, the casing penetration portions 102 formed in one surface (the top surface based on FIG. 7) of the casing part 100 may be provided to evaporate the water moving along a first energy generation membrane 210, and the casing penetration portions 102 formed in the other surface (the bottom surface based on FIG. 5) of the casing part 100 may be provided to evaporate the water moving along a second energy generation membrane 220.

According to another embodiment of the present disclosure, the casing penetration portion may have a quadrangular shape, an elliptical shape, or other shapes. Alternatively, only a single casing penetration portion may be provided in each of one surface and the other surface of the casing part.

According to the exemplary embodiment of the present disclosure, the energy generation system 10 may include a partition member 130 configured to divide an internal space of the casing part 100 into a plurality of spaces. The energy generation membranes 200 may be independently provided in the spaces defined by the partition member 130.

For example, the partition member 130 may be configured to divide the internal space of the casing part 100 into a first space 132 and a second space 134. The energy generation membranes 200 may include the first energy generation membrane 210 accommodated in the first space 132, and the second energy generation membrane 220 accommodated in the second space 134.

The partition member 130 may have various structures capable of dividing the internal space of the casing part 100 into the first space 132 and the second space 134. The present disclosure is not restricted or limited by the structure of the partition member 130.

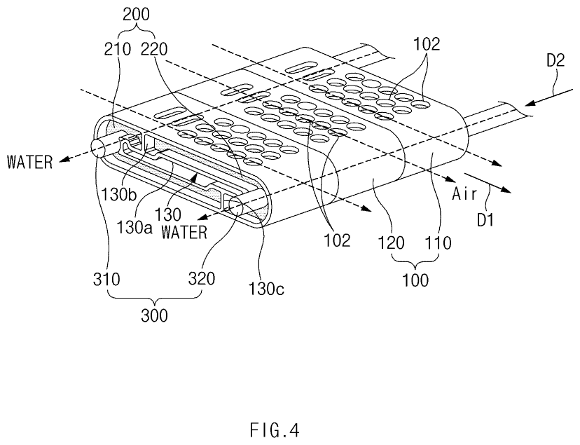

With reference to FIG. 4, according to the exemplary embodiment of the present disclosure, the partition member 130 may include a partition body 130a provided in the casing part 100 and spaced apart from an inner surface of the casing part 100, a first support protrusion 130b provided on one surface of the partition body 130a and supported on the inner surface of the casing part 100, and a second support protrusion 130c provided on the other surface of the partition body 130a and supported on the inner surface of the casing part 100.

For example, the partition body 130a may have an approximately flat plate shape and be disposed at a central portion of the casing part 100. The first support protrusion 130b may be provided on one surface (the top surface based on FIG. 7) of the partition body 130a and supported on the inner surface of the casing part 100. The second support protrusion 130c may be provided on the other surface (the bottom surface based on FIG. 7) of the partition member 130 and supported on the inner surface of the casing part 100. A space between the partition body 130a and the casing part 100 may be divided into the first and second spaces 132 and 134 each having an approximately “J” shape by the first support protrusion 130b and the second support protrusion 130c.

For example, the partition body 130a, the first support protrusion 130b, and the second support protrusion 130c may be formed as a unitary one-piece structure by injection molding. According to another embodiment of the present disclosure, the partition body, the first support protrusion, and the second support protrusion may be provided individually and then separately attached or assembled to constitute the partition member.

Meanwhile, in the embodiment of the present disclosure illustrated and described above, the example has been described in which the first space 132 and the second space 134 are each defined as having a curved shape (e.g., a “J” shape) by the partition member 130. However, according to another embodiment of the present disclosure, the first space and the second space may each be defined as having a straight shape or other shapes by the partition member.

In addition, in the embodiment of the present disclosure illustrated and described above, the example has been described in which the internal space of the casing part 100 is divided into two spaces (the first space and the second space) by the partition member 130. However, according to another embodiment of the present disclosure, the partition member may be used to divide the internal space of the casing part into three or more spaces.

Further, in the embodiment of the present disclosure illustrated and described above, the example has been described in which the energy generation membranes 200 are respectively provided in the plurality of spaces (e.g., the first space and the second space) separated by the partition member 130. However, according to another embodiment of the present disclosure, the separate partition member may be excluded, and only a single energy generation membrane may be provided in the casing part.

The energy generation membrane 200 is configured to generate electrical energy by using the water supplied from the absorptive member 300.

More specifically, the energy generation membrane 200 is supported in the casing part 100 so as to be exposed to the outside of the casing part 100 through the casing penetration portions 102 and generate electrical energy on the basis of a potential difference between two opposite ends made by the movement and evaporation of the water supplied from the absorptive member 300.

According to the exemplary embodiment of the present disclosure, the energy generation membranes 200 may include the first energy generation membrane 210 accommodated in the first space 132, and the second energy generation membrane 220 accommodated in the second space 134.

For example, the first energy generation membrane 210 may have a curved shape (e.g., a “J” shape) corresponding to the first space 132, an inner surface of the first energy generation membrane 210 may be tightly attached to the partition member 130, and an outer surface of the first energy generation membrane 210 may be tightly attached to the inner surface of the casing part 100.

Likewise, the second energy generation membrane 220 may have a curved shape (e.g., a “J” shape) corresponding to the second space 134, an inner surface of the second energy generation membrane 220 may be tightly attached to the partition member 130, and an outer surface of the second energy generation membrane 220 may be tightly attached to the inner surface of the casing part 100.

The energy generation membrane 200 (e.g., the first energy generation membrane and the second energy generation membrane) may have various structures capable of generating electrical energy on the basis of a potential difference between the two opposite ends (two opposite ends of the energy generation membrane) made when the water supplied to one end of the energy generation membrane 200 evaporates while being moved to the other end of the energy generation membrane 200 (moved by capillarity). The present disclosure is not restricted or limited by the structure of the energy generation membrane 200.

According to the exemplary embodiment of the present disclosure, the energy generation membrane 200 (e.g., the first energy generation membrane and the second energy generation membrane) may include a hydrophilic fiber membrane (not illustrated), and a conductive polymer layer (not illustrated) applied onto a surface of the hydrophilic fiber membrane.

The hydrophilic fiber membrane may be made of various materials capable of absorbing water. The present disclosure is not restricted or limited by the material and properties of the hydrophilic fiber membrane. For example, the hydrophilic fiber membrane may be made of a non-woven fabric.

The conductive polymer layer may be made of various polymer materials having conductivity. The present disclosure is not restricted or limited by the material and properties of the conductive polymer layer. For example, the conductive polymer layer may be made of carbon.

For reference, because the energy generation membrane 200 according to the embodiment of the present disclosure includes the hydrophilic fiber membrane and the conductive polymer layer according to the well-known technology having the above-mentioned configuration and operational principle, a detailed description thereof will be omitted.

The absorptive member 300 is provided at one end of the energy generation membrane 200 and supplies the water that is a source for generating electrical energy.

More specifically, the absorptive member 300 may be provided to penetrate the casing part 100 while being in contact with the energy generation membrane 200. The water supplied to (absorbed by) the absorptive member 300 may move from the absorptive member 300 to the energy generation membrane 200 through the contact portion between the absorptive member 300 and the energy generation membrane 200.

The absorptive member 300 may be made of various materials capable of absorbing water. The present disclosure is not restricted or limited by the material and properties of the absorptive member 300.

For example, a typical porous body, such as a sponge, may be used as the absorptive member 300.

According to the exemplary embodiment of the present disclosure, the absorptive members 300 may include a first absorptive member 310 provided to penetrate the casing part 100 (e.g., the first casing member and the second casing member) while being in contact with the first energy generation membrane 210 and configured to supply the water to the first energy generation membrane 210, and a second absorptive member 320 provided to penetrate the casing part 100 (e.g., the first casing member and the second casing member) while being in contact with the second energy generation membrane 220 and configured to supply the water to the second energy generation membrane 220.

The absorptive member 300 (e.g., the first absorptive member and the second absorptive member) may have various structures capable of being in contact with the energy generation membrane 200 (e.g., the first energy generation membrane and the second energy generation membrane). The present disclosure is not restricted or limited by the structure of the absorptive member 300.

For example, the absorptive member 300 may have a straight shape having an approximately circular cross-section. Alternatively, the absorptive member 300 may have a curved shape or other shapes.

In particular, the absorptive member 300 may be interposed between an end of the partition member 130 and the energy generation membrane 200 (a bent portion of the energy generation membrane) and tightly attached to (be in surface contact with) the energy generation membrane 200.

Because the absorptive member 300 is tightly attached to (is in surface contact with) the energy generation membrane 200 as described above, it is possible to obtain an advantageous effect of ensuring a sufficient contact area between the absorptive member 300 and the energy generation membrane 200 and improving efficiency in moving the water from the absorptive member 300 to the energy generation membrane 200. According to another embodiment of the present disclosure, the absorptive member may be in line contact or point contact with the energy generation membrane.

For reference, in the embodiment of the present disclosure illustrated and described above, the example has been described in which the first absorptive member 310 and the second absorptive member 320 independently supply the water to the first energy generation membrane 210 and the second energy generation membrane 220. However, according to another embodiment of the present disclosure, only a single absorptive member may be used to supply the water to the first energy generation membrane and the second energy generation membrane. For example, the absorptive member may have a curved shape capable of continuously penetrating the first energy generation membrane and the second energy generation membrane.

With the above-mentioned structure, the water supplied along the absorptive member 300 may be slowly supplied to one end of the energy generation membrane 200 (e.g., the first energy generation membrane and the second energy generation membrane), and the water supplied to one end of the energy generation membrane 200 may evaporate to the outside of the casing part 100 through the casing penetration portions 102 while being moved (moved by capillarity) to the other end of the energy generation membrane 200 along the energy generation membrane 200.

Therefore, one end of the energy generation membrane 200 comes into a wet state, and the other end of the energy generation membrane 200 comes into a dry state, such that a potential difference may occur between the two opposite ends of the energy generation membrane 200, and the energy generation membrane 200 may generate electrical energy.

As described above, in the embodiment of the present disclosure, an appropriate amount of water, which is required for the energy generation membrane 200 to generate electrical energy, may be stably supplied to the energy generation membrane 200 by supplying the water to the energy generation membrane 200 by means of the absorptive member 300 without supplying the water directly to the energy generation membrane 200. Therefore, it is possible to obtain an advantageous effect of improving the electrical energy generation efficiency and stability.

That is, if an excessive amount of water, which is larger than necessary, is supplied to the energy generation membrane 200 (at a flow rate of the water higher than a preset reference flow rate), the electrical energy generation efficiency and stability of the energy generation membrane 200 may be degraded. In contrast, in the embodiment of the present disclosure, the water in the absorptive member 300 slowly moves to the energy generation membrane 200 along the contact portion between the absorptive member 300 and the energy generation membrane 200, such that an excessive amount of water, which is larger than necessary, may be prevented from being supplied to the energy generation membrane 200. Therefore, it is possible to obtain an advantageous effect of improving the electrical energy generation efficiency and stability.

Moreover, according to the embodiment of the present disclosure, even if the supply of the water to the absorptive member 300 is stopped temporarily, the water, which has already been absorbed by the absorptive member 300, may be supplied to the energy generation membrane 200. Therefore, it is possible to obtain an advantageous effect of improving the electrical energy generation efficiency and stability.

According to the exemplary embodiment of the present disclosure, the energy generation system 10 may include first electrode port parts 104 each provided in the casing part 100 so that one end of the energy generation membrane 200 may be exposed, and second electrode port parts 106 each provided in the casing part 100 so that the other end of the energy generation membrane 200 may be exposed.

For example, the first electrode port part 104 may be provided to connect a minus (−) electrode, and the second electrode port part 106 may be provided to connect a plus (+) electrode.

The first electrode port part 104 and the second electrode port part 106 may each be provided in the form of a hole formed through the wall surface of the casing part 100.

Hereinafter, an example will be described in which the first electrode port part 104 (or the second electrode port part), through which one end of the energy generation membrane 200 is exposed, is provided in one surface of the casing part 100, and the second electrode port part 106 (or the first electrode port part), through which the other end of the energy generation membrane 200 is exposed, is provided in the other surface of the casing part 100.

The first electrode port part 104 and the second electrode port part 106 may be variously changed in structures in accordance with required conditions and design specifications. The present disclosure is not restricted or limited by the structures of the first electrode port part 104 and the second electrode port part 106.

For example, the first electrode port part 104 and the second electrode port part 106 may each have an approximately quadrangular hole shape. According to another embodiment of the present disclosure, the first electrode port part and the second electrode port part may each have a circular shape or other shapes. Alternatively, separate conductive clips (e.g., steel clips) (not illustrated) for connecting the electrodes may be provided in the first and second electrode port parts.

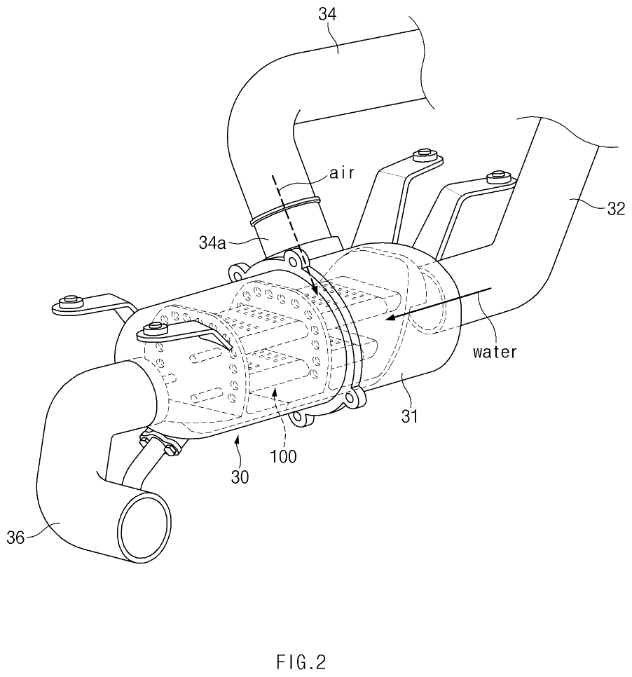

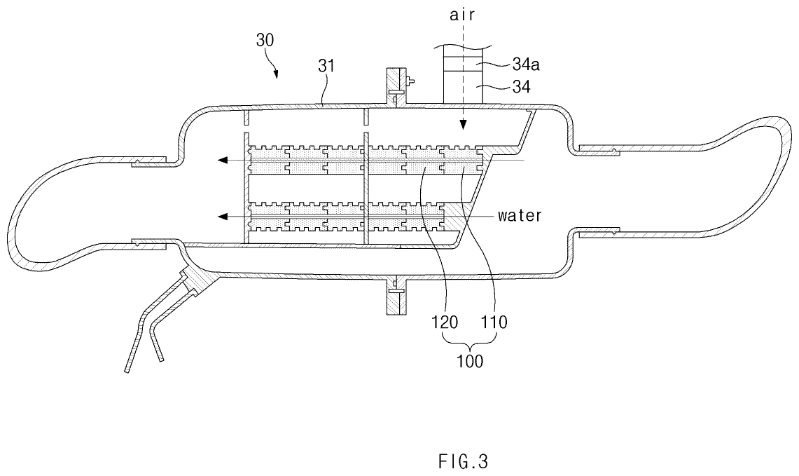

With reference back to FIGS. 2 and 3, according to the exemplary embodiment of the present disclosure, the energy generation system 10 may include the housing member 31 configured to surround the entire periphery of the casing part 100.

The housing member 31 is provided to establish a high-temperature, dry ambience in the peripheral space of the casing part 100 and facilitate the evaporation of the water supplied to the energy generation membrane 200.

The housing member 31 may have various structures capable of surrounding the periphery of the casing part 100. The present disclosure is not restricted or limited by the structure and shape of the housing member 31.

For example, the housing member 31 may have an approximately cylindrical shape. The plurality of casing parts 100 may be provided in the housing member 31.

According to the exemplary embodiment of the present disclosure, the energy generation system 10 may include an air inlet port (not illustrated) provided in the housing member 31 so that heated air is introduced through the air inlet port, and an air discharge port (not illustrated) provided in the housing member 31 so that the heated air is discharged through the air discharge port. The peripheral space of the casing part 100 in the housing member 31 may be filled with the heated air.

The air inlet port and the air discharge port may be provided at various positions on the housing member 31 in accordance with required conditions and design specifications. The present disclosure is not restricted or limited by the positions of the air inlet port and the air discharge port and the movement direction of the heated air.

For example, the air inlet port may be provided at one end of the housing member 31 based on the longitudinal direction, and the air discharge port may be provided at the other end of the housing member 31.

The heated air (high-temperature, dry air) introduced into the housing member 31 through the air inlet port may pass through the periphery of the casing part 100 and then be discharged, together with the evaporated water, to the outside of the housing member 31 along a discharge line 36 connected to the air discharge port.

For reference, the air introduced into the air inlet port may be heated in various ways in accordance with required conditions and design specifications. The present disclosure is not restricted or limited by the air heating method and the air heating condition.

According to the exemplary embodiment of the present disclosure, the energy generation system 10 may include a second connection line 34 having one end disposed between the air compressor 24 and the humidifier 26 and connected to the air supply line 22, and the other end connected to the second energy generation part 30. A part of the air having passed through the air compressor 24 (the high-temperature air compressed by the air compressor) may be supplied to the second energy generation part 30 along the second connection line 34.

The second connection line 34 may have various structures capable of connecting the air supply line 22 and the second energy generation part 30 at a downstream side of the air compressor 24. The present disclosure is not restricted or limited by the structure and shape of the second connection line 34.

For example, an end of the second connection line 34 may be connected to the air inlet port of the housing member 31, and the high-temperature air having passed through the air compressor 24 may be supplied to the housing member 31 through the air inlet port.

As described above, in the embodiment of the present disclosure, the high-temperature air having passed through the air compressor 24 may be supplied to the second energy generation part 30 without additionally providing an air supply device for supplying high-temperature air to the second energy generation part 30. Therefore, it is possible to obtain an advantageous effect of improving the energy efficiency, simplifying the structure, and improving the spatial utilization and the degree of design freedom.

In the embodiment of the present disclosure illustrated and described above, the example has been described in which the high-temperature air having passed through the air compressor 24 is supplied to the second energy generation part 30. However, according to another embodiment of the present disclosure, high-temperature, dry air, which is heated by electrical components (power electronic parts) in a vehicle that use power generated by the fuel cell stack 21 as an energy source, may be supplied to the second energy generation part 30, or other air supply devices may be used to supply high-temperature air to the second energy generation part 30.

According to the exemplary embodiment of the present disclosure, the first direction in which the heated air moves from the air inlet port to the air discharge port may be defined to be perpendicular to the second direction in which the water moves in the longitudinal direction of the absorptive member.

As described above, in the embodiment of the present disclosure, the heated air is introduced into the housing member 31 in the direction (first direction) perpendicular to the longitudinal direction (second direction) of the absorptive member 300, such that the heated air may move while passing over the periphery of the casing part 100 (contact efficiency between the energy generation membrane and the heated air may be improved). Therefore, it is possible to obtain an advantageous effect of further facilitating the evaporation of the water by the heated air (the evaporation of the water supplied to the energy generation membrane 200).

According to another embodiment of the present disclosure, the direction in which the heated air moves from the air inlet port to the air discharge port may be defined in accordance with the longitudinal direction of the absorptive member.

In addition, according to the exemplary embodiment of the present disclosure, the energy generation system 10 may include a support member (not illustrated) configured to support the casing part 100 on the housing member 31.

The support member may have various structures capable of supporting the casing part 100 on the housing member 31. The present disclosure is not restricted or limited by the structure of the support member.

For example, the support member may have an approximately circular plate shape and be approximately provided between the housing member 31 and the casing part 100 to support a boundary portion between the first casing member 110 and the second casing member 120. In particular, a plurality of through-holes may be formed in the support member so that the heated air moves through the plurality of through-holes.

Meanwhile, in the embodiment of the present disclosure illustrated and described above, the example has been described in which the plurality of casing parts 100 are provided in the housing member 31. However, according to another embodiment of the present disclosure, only a single casing part may be provided in the housing member 31.

According to the exemplary embodiment of the present disclosure, the energy generation system 10 may include a valve provided in the second connection line 34 and configured to selectively open or close the second connection line 34.

In this case, the configuration in which the second connection line 34 is selectively opened or closed may be defined as including both a configuration in which a flow of air moving through the second connection line 34 is regulated in an on/off manner and a configuration in which a flow rate is adjusted by adjusting an opening ratio.

Various valve means capable of selectively opening or closing the second connection line 34 may be used as the valve. The present disclosure is not restricted or limited by the type and operational structure of the valve. For example, a typical solenoid valve may be used as the valve.

According to the exemplary embodiment of the present disclosure, the energy generation system 10 may include a temperature sensor 31a provided in the second energy generation part 30 and configured to sense an internal temperature of the second energy generation part 30 (an internal temperature of the housing member 31), and a humidity sensor 31b provided in the second energy generation part 30 and configured to sense an internal humidity of the second energy generation part 30 (an internal humidity of the housing member 31). The valve may selectively open or close the second connection line 34 in response to signals detected by the temperature sensor 31a and the humidity sensor 31b.

A time point at which the second connection line 34 is opened or closed by the valve may be variously changed in accordance with required conditions and design specifications.

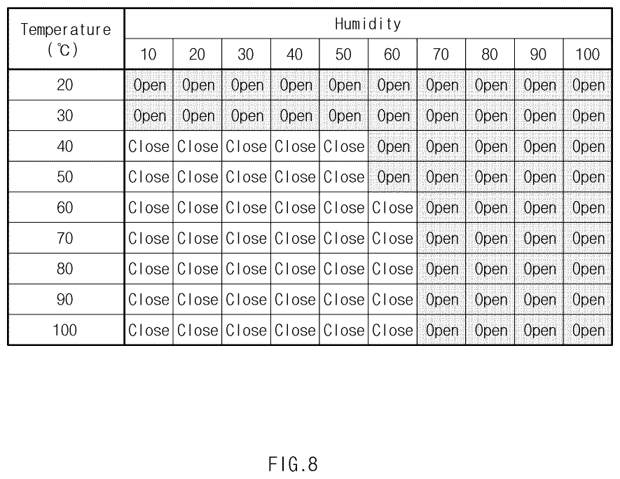

For example, with reference to FIG. 8, when the internal humidity of the housing member 31 is 70% or more, the valve may open the second connection line 34 at ordinary times. When the internal humidity of the housing member 31 is less than 70%, the valve may open or close the second connection line 34 on the basis of the internal temperature of the housing member 31.

For example, in a state in which the internal humidity of the housing member 31 is 70%, the valve may open the second connection line 34 when the internal temperature of the housing member 31 is less than 50° C., and the valve may close the second connection line 34 when the internal temperature of the housing member 31 is 60° C. or more.

As described above, in the embodiment of the present disclosure, the second connection line 34 is selectively opened or closed on the basis of the internal temperature and the internal humidity of the housing member 31. Therefore, it is possible to obtain an advantageous effect of optimizing the electrical energy generation condition by the energy generation membrane and improving the electrical energy generation efficiency by the energy generation membrane.

According to the exemplary embodiment of the present disclosure, the energy generation system 10 may include an air flow rate sensor 34a provided in the second connection line 34 and configured to sense a flow rate of air moving along the second connection line 34, and a controller 40 configured to control an opening ratio of the valve in response to a signal detected by the air flow rate sensor 34a.

Various sensors (e.g., electromagnetic flow rate sensors) capable of sensing the flow rate of the air moving along the second connection line 34 may be used as the air flow rate sensor 34a. The present disclosure is not restricted or limited by the type and structure of the air flow rate sensor 34a.

For example, the air flow rate sensor 34a may be provided adjacent to an outlet of the second connection line 34.

The controller 40 is configured to adjust the opening ratio of the valve in response to a signal detected by the air flow rate sensor 34a.

For example, when the flow rate of the air moving along the second connection line 34 is lower than a preset reference flow rate, the controller 40 may increase the opening ratio of the valve.

In contrast, when the flow rate of the air moving along the second connection line 34 is higher than the preset reference flow rate, the controller 40 may decrease the opening ratio of the valve.

For reference, the controller 40 may include a central processing unit (CPU) or a semiconductor device (e.g., an MCU) that processes instructions stored in a memory and/or a storage. Examples of the memory and the storage may include various types of volatile or non-volatile storage media. Examples of the memory may include a read only memory (ROM) and a random-access memory (RAM).

For example, the controller 40 may transmit a pulse width modulation (PWM) signal for controlling the opening degree of the valve on the basis of the flow rate of the air moving along the second connection line 34.

As described above, in the embodiment of the present disclosure, the opening ratio of the valve is adjusted on the basis of the flow rate of the air moving along the second connection line 34 (a supply flow rate of the high-temperature air supplied to the housing member 31). Therefore, it is possible to obtain an advantageous effect of further optimizing the electrical energy generation condition of the energy generation membrane and further improving the electrical energy generation efficiency by the energy generation membrane.

According to the exemplary embodiment of the present disclosure, the energy generation system 10 may include a muffler 50 connected to an outlet of the second energy generation part 30.

The muffler 50 may be provided to store and discharge the water having passed through the second energy generation part 30. The present disclosure is not restricted or limited by the type and structure of the muffler 50.

In particular, the muffler 50 may include a silencer configured to reduce fluid noise caused by the movement of the water and the movement of the air.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. An energy generation system comprising:
a first energy generation part configured to generate electrical energy from an electrochemical reaction of a target fluid; and
a second energy generation part configured to:
receive water discharged from the first energy generation part; and
generate additional electrical energy from a potential difference made by a movement and evaporation of the water.

2. The energy generation system of claim 1, wherein the first energy generation part comprises:
a fuel cell stack;
an air compressor provided in an air supply line through which air is supplied to the fuel cell stack, the air compressor being configured to compress the air to be supplied to the fuel cell stack; and
a humidifier provided in the air supply line and configured to humidify the air to be supplied to the fuel cell stack by using the water discharged from the fuel cell stack.

3. The energy generation system of claim 2, further comprising:
a first connection line configured to connect the humidifier and the second energy generation part,
wherein the water discharged from the fuel cell stack passes through the humidifier and is supplied to the second energy generation part along the first connection line.

4. The energy generation system of claim 2, further comprising:
a second connection line having one end disposed between the air compressor and the humidifier and connected to the air supply line, and another end connected to the second energy generation part,
wherein a part of the air having passed through the air compressor is supplied to the second energy generation part along the second connection line.

5. The energy generation system of claim 4, further comprising:
a valve provided in the second connection line and configured to selectively open or close the second connection line.

6. The energy generation system of claim 5, further comprising:
a temperature sensor provided in the second energy generation part and configured to sense an internal temperature of the second energy generation part; and
a humidity sensor provided in the second energy generation part and configured to sense an internal humidity of the second energy generation part,
wherein the valve selectively opens or closes the second connection line in response to signals detected by the temperature sensor and the humidity sensor.

7. The energy generation system of claim 5, further comprising:
an air flow rate sensor provided in the second connection line and configured to sense a flow rate of air moving along the second connection line; and
a controller configured to control an opening ratio of the valve in response to a signal detected by the air flow rate sensor.

8. The energy generation system of claim 1, wherein the second energy generation part comprises:
a casing part having a casing penetration portion;
an energy generation membrane supported in the casing part so as to be exposed to an outside of the casing part through the casing penetration portion and configured to generate the additional electrical energy from the potential difference between two opposite ends of the energy generation membrane, wherein the potential difference is made by the movement and evaporation of the water;
an absorptive member provided to penetrate the casing part while being in contact with the energy generation membrane and configured to supply the water to the energy generation membrane; and
a housing member provided to surround an entire periphery of the casing part.

9. The energy generation system of claim 8, further comprising:
a partition member configured to divide an internal space of the casing part into a first space and a second space,
wherein the energy generation membrane comprises:
a first energy generation membrane accommodated in the first space; and
a second energy generation membrane accommodated in the second space.

10. The energy generation system of claim 9, wherein:
an inner surface of the first energy generation membrane and an inner surface of the second energy generation membrane are tightly attached to the partition member, and an outer surface of the first energy generation membrane and an outer surface of the second energy generation membrane are tightly attached to an inner surface of the casing part.

11. The energy generation system of claim 9, wherein the absorptive member comprises:
a first absorptive member provided to penetrate the casing part while being in contact with the first energy generation membrane and configured to supply the water to the first energy generation membrane; and
a second absorptive member provided to penetrate the casing part while being in contact with the second energy generation membrane and configured to supply the water to the second energy generation membrane.

12. The energy generation system of claim 8, wherein the casing part comprises:
a first casing member configured to support the energy generation membrane; and
a second casing member configured to support the energy generation membrane independently of the first casing member and
wherein the absorptive member is provided to continuously penetrate the first casing member and the second casing member.

13. The energy generation system of claim 12, wherein the second casing member is connected in series to an end of the first casing member in a longitudinal direction of the absorptive member.

14. The energy generation system of claim 13, further comprising:
a guide protrusion provided at an end of the second casing member corresponding to the end of the first casing member; and
a guide groove provided at the end of the first casing member and configured to accommodate the guide protrusion.

15. The energy generation system of claim 13, wherein the first casing member and the second casing member have a same structure.

16. The energy generation system of claim 9, wherein the partition member comprises:
a partition body provided in the casing part and spaced apart from an inner surface of the casing part;
a first support protrusion provided on one surface of the partition body and supported on the inner surface of the casing part; and
a second support protrusion provided on another surface of the partition body and supported on the inner surface of the casing part.

17. The energy generation system of claim 8, further comprising:
a first electrode port part provided in the casing part so that one end of the energy generation membrane is exposed; and
a second electrode port part provided in the casing part so that another end of the energy generation membrane is exposed.

18. The energy generation system of claim 8, wherein the energy generation membrane comprises:
a hydrophilic fiber membrane; and
a conductive polymer layer applied onto a surface of the hydrophilic fiber membrane.

19. An energy generation system, comprising:
a first energy generation part configured to generate electrical energy from an electrochemical reaction of a target fluid; and
a second energy generation part, comprising:
a casing part comprising a casing penetration portion;
an energy generation membrane supported in the casing part so as to be exposed to an outside of the casing part through the casing penetration portion; and
an absorptive member in contact with the energy generation membrane and configured to supply water to the energy generation membrane,
wherein:
the energy generation membrane is configured to generate additional electrical energy from a potential difference between a first end of the energy generation membrane and a second end of the energy generation membrane,
the potential difference is caused by movement and evaporation of the water between the first end and the second end, and
the water is supplied to the absorptive member from the first energy generation part and is a product of the electrochemical reaction.

20. An energy generation part, comprising:
a casing part comprising a casing penetration portion;
an energy generation membrane supported in the casing part so as to be exposed to an outside of the casing part through the casing penetration portion; and
an absorptive member in contact with the energy generation membrane and configured to supply water to the energy generation membrane,
wherein:
the absorptive member receives the water from a different energy generation part in which the water is produced by an electrochemical reaction,
the energy generation membrane is configured to generate electrical energy from a potential difference between a first end of the energy generation membrane and a second end of the energy generation membrane,
the potential difference is caused by movement and evaporation of the water between the first end and the second end.
